(19) United States
(12) Patent Application Publication
(10) Pub. No.: US 2008/0231999 A1
(43) Pub. Date: Sep. 25, 2008

(54) TUNNELING MAGNETORESISTIVE DEVICE AND MAGNETIC HEAD COMPRISING THE SAME

(75) Inventors: Eun-sik Kim, Seoul (KR); Kook-hyun Sunwoo, Hwaseong-si (KR); Jongill Hong, Hwaseong-si (KR); In-jun Hwang, Yongin-si (KR); Hyoung-joon Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/952,278

(22) Filed: Dec. 7, 2007

(30) Foreign Application Priority Data
Mar. 20, 2007 (KR) 10-2007-0027293

(51) Int. Cl. G11B 5/33

(52) U.S. Cl. 360/315

(57) ABSTRACT

A tunneling magnetoresistive device and a magnetic head including the tunneling magnetoresistive device are provided. The tunneling magnetoresistive device includes a pinned layer and a free layer formed on either side of a tunneling barrier layer, wherein the tunneling barrier layer includes Te—O.

### CROSS-REFERENCE TO RELATED PATENT APPLICATION

This application claims priority from Korean Patent Application No. 10-2007-0027293, filed on Mar. 20, 2007, in the Korean Intellectual Property Office, the disclosure of which is incorporated herein in its entirety by reference.

### BACKGROUND OF THE INVENTION

1. Field of the Invention

The present invention relates to a semiconductor device and, more particularly, to a tunneling magnetoresistive device and a magnetic head including the same.

2. Description of the Related Art

A tunneling magnetoresistive (TMR) device includes a pinned layer and a free layer formed on both sides of a tunneling barrier layer. The pinned layer is a ferromagnetic layer which has a magnetization direction that is fixed, and the free layer is a ferromagnetic layer which has a magnetization direction that can be freely changed by an external magnetic field. The tunneling barrier layer is an insulating layer through which electrons can tunnel, and which magnetically separates the pinned layer and the free layer.

Assuming that when the magnetization directions of the pinned layer and the free layer are identical, the resistance of the TMR device is a first resistance R1, and that when the magnetization directions of the pinned layer and the free layer are opposite, the resistance of the TMR device is a second resistance R2, the first resistance R1 is known to be lower than the second resistance R2. Therefore, a tunneling current that flows through the TMR device when the magnetization directions of the pinned layer and the free layer are identical is greater than a tunneling current that flows through the TMR device when the magnetization directions of the pinned layer and the free layer are opposite. Accordingly, the magnetization state of the free layer or the magnetization state of a storage medium that affects the free layer can be determined by measuring the tunneling current.

The magnetoresistive (MR) ratio of the TMR device is expressed by the following equation.

$$MR ratio = \frac{R 2 - R 1}{R 1} \qquad [ Equation 1 ]$$

As the MR ratio increases, the determination of the magnetization direction of the pinned layer and the free layer becomes easier, thus, a TMR device having high information reproducing and writing performance can be manufactured.

The conventional TMR device that uses the tunneling barrier layer formed of AlOₓ or MgO has a relatively high MR ratio. However, the tunneling barrier layer of the conventional TMR device has high resistance. When the tunneling barrier layer has a high resistance, power consumption increases and operation speed is reduced. Therefore, research has been conducted to reduce the resistance of the tunneling barrier layer. A method of reducing the resistance of the tunneling barrier layer is to reduce the thickness of the tunneling barrier layer. However, when the thickness of the tunneling barrier layer is reduced below the critical value, the MR ratio is rapidly reduced, and as a result, the tunneling barrier layer can lose its function. Also, if the tunneling barrier layer is too thin, thickness deviation becomes large and the effect of defects such as pin holes is large. Thus, the uniformity and reliability of the device characteristics cannot be ensured. Therefore, there is a limit in reducing the resistance of the tunneling barrier layer by reducing the thickness of the tunneling barrier layer.

### SUMMARY OF THE INVENTION

To solve the above and/or other problems, the present invention provides a tunneling magnetoresistive (TMR) device having a tunneling barrier layer that has low resistance and can ensure a sufficient MR ratio for use as a read sensor.

The present invention also provides a magnetic head including the TMR device.

According to an aspect of the present invention, there is provided a tunneling magnetoresistive device having a pinned layer and a free layer formed on either side of a tunneling barrier layer, wherein the tunneling barrier layer is formed of Te—O.

The tunneling barrier layer may be formed of TeO₂O₂.

The tunneling barrier layer may have a thickness of 0.5 to 4 nm.

The tunneling barrier layer may have a resistance R(Ω·μm²) in a range of 0<R≦4.

The tunneling magnetoresistive device may further comprise an anti-ferromagnetic layer formed on a lower surface of the pinned layer.

The tunneling magnetoresistive device may further comprise a non-magnetic conductive layer, another pinned layer having a magnetization direction opposite to a magnetization direction of the pinned layer, and an anti-ferromagnetic layer sequentially formed on the lower surface of the pinned layer.

According to an aspect of the present invention, there is provided a magnetic head having a reproducing unit that comprises a tunneling magnetoresistive device, wherein the tunneling magnetoresistive device comprises: a tunneling barrier layer formed of Te—O; and a free layer and a pinned layer formed on either side of the tunneling barrier layer.

The tunneling barrier layer may be formed of TeO₂.

The tunneling barrier layer may have a thickness of 0.5 to 4 nm.

The tunneling barrier layer may have a resistance R (Ω·μm²) in a range of 0<R≦4.

The magnetic head may further comprise a shielding layer formed on at least one surface of both surfaces of the tunneling magnetoresistive device facing each other.

The magnetic head may further comprise a magnetic recording unit separated from the tunneling magnetoresistive device.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a tunneling magnetoresistive (TMR) device according to an exemplary embodiment of the present invention;

FIG. 2 is a cross-sectional view of a TMR device according to another exemplary embodiment of the present invention;

FIG. 3 is a cross-sectional view of a TMR device according to another exemplary embodiment of the present invention;

FIG. 4 is a perspective view of a magnetic head according to an exemplary embodiment of the present invention; and

FIG. 5 is a cross-sectional view of a magnetic memory according to an exemplary embodiment of the present invention.

### DETAILED DESCRIPTION OF EXEMPLARY EMBODIMENT OF THE INVENTION

The present invention will now be described more fully with reference to the accompanying drawings in which exemplary embodiments of the invention are shown. In the drawings, the thicknesses of layers and regions are exaggerated for clarity, and like reference numerals refer to the like elements.

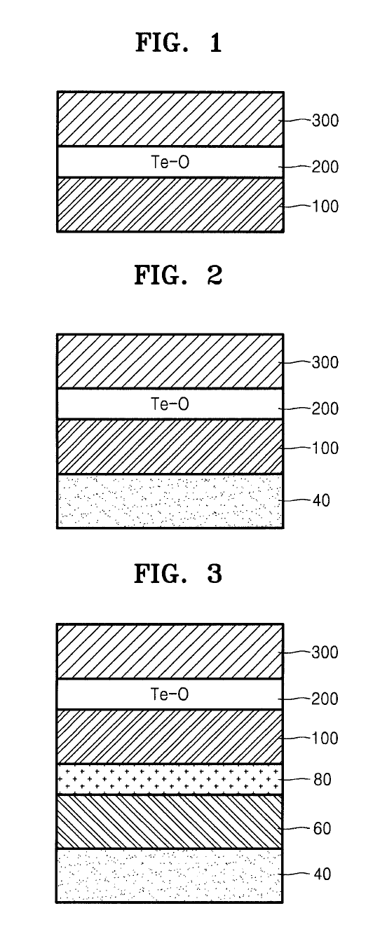

FIG. 1 is a cross-sectional view of a tunneling magnetoresistive (TMR) device according to an exemplary embodiment of the present invention.

Referring to FIG. 1, a pinned layer 100 and a free layer 300 are formed on either side of a tunneling barrier layer 200. The pinned layer 100 and the free layer 300 can be formed of a ferromagnetic material such as Fe, Co, Fe—Co, or Fe—Co alloy. The tunneling barrier layer 200 includes Te—O, for example, a TeO₂ layer. The TeO₂ layer can be formed by a predetermined deposition method, for example, a physical vapor deposition (PVD) method such as sputtering.

The tunneling barrier layer 200 can be formed to a thickness of 0.5 to 4 nm, preferably, but not necessarily, 1 to 2.5 nm. The resistance R(Ω·μm²) of the tunneling barrier layer 200 varies according to the thickness of the tunneling barrier layer 200 and the magnetization direction of the pinned layer 100 and the free layer 300, and can be 0<R<4, and preferably, but not necessarily, 0<R≦2.

The tunneling barrier layer 200 formed of TeO₂ has a resistance much smaller than a conventional tunneling barrier layer formed of AlOₓ or MgO when layers having the same thickness are compared. Therefore, according to the present exemplary embodiment, a TMR device having a low resistance and a sufficient MR ratio for use as a read sensor can be realized.

Tables 1 through 3 summarize resistances (ω·μm²) and MR ratios of first through third samples manufactured having the structure of FIG. 1. In Tables 1 through 3, R1 is a first resistance, that is, the resistance of a sample when the magnetization directions of the pinned layer 100 and the free layer 300 are identical, and R2 is a second resistance, that is, the resistance of a sample when the magnetization directions of the pinned layer 100 and the free layer 300 are opposite. The MR ratios (%) were calculated using equation 1 shown above. The R1 and R2 values used in the calculation have been rounded for inclusion in the tables below.

TABLE 1

| TeO₂ thickness (nm) | R1(Ω · μm²) | R2(Ω · μm²) | MR ratio (%) |
|---|---|---|---|
| 0.9 | 0.013 | 0.028 | 107 |

TABLE 2

| TeO₂ thickness (nm) | R1(Ω · μm²) | R2(Ω · μm²) | MR ratio (%) |
|---|---|---|---|
| 0.9 | 0.017 | 0.019 | 14 |
| 1.66 | 2.29 | 3.25 | 42 |
| 2.42 | 402 | 666 | 66 |

TABLE 3

| TeO₂ thickness (nm) | R1(Ω · μm²) | R2(Ω · μm²) | MR ratio (%) |
|---|---|---|---|
| 0.9 | 0.015 | 0.016 | 5 |

The first and second resistances R1 and R2 are simulation results using a first principle simulation. The first principle simulation is a quantum mechanic simulation used in physical and chemical fields, and uses the principle that characteristics of a predetermined material changes according to atomic structure and the spin state of electrons of the predetermined material. In the first principle simulation for measuring the first and second resistances R1 and R2, the pinned layer 100 and the free layer 300 of the first sample (shown in Table 1) are Fe layers (BCC), the pinned layer 100 and the free layer 300 of the second sample (shown in Table 2) are Co layers (FCC), and the pinned layer 100 and the free layer 300 of the third sample (shown in Table 3) are Co_{87.5}Fe_{12.5} layers (FCC). The crystal orientation plane of the Fe layers (BCC), the Co layers (FCC), and the Co_{87.5}Fe_{12.5} layers (FCC), that is, the crystal face parallel to the tunneling barrier layer 200, is a (100) plane. The crystal structure of the tunneling barrier layer 200 formed of TeO₂ is tetragonal, the first lattice parameter thereof is 4.81 Å, and the crystal orientation plane thereof is a (100) plane.

In order to compare the characteristics of the TeO₂ layer and the MgO layer, a simulation with respect to a related art sample (a fourth sample) having the tunneling barrier layer formed of MgO was performed. That is, the first and second resistances R1 and R2 were calculated with respect to the fourth sample having a pinned layer (Fe)/tunneling barrier layer (MgO)/free layer (Fe) structure using the first principle simulation described above. As a result, when the thickness of the MgO layer was 0.9 nm, the first and second resistances R1 and R2 of the fourth sample respectively were 0.806 and 23.6, when the thickness of the MgO layer was 1.71 nm, the first and second resistances R1 and R2 respectively were 944 and 8.62×10⁴, and when the thickness of the MgO layer was 2.52 nm, first and second resistances R1 and R2 respectively were 1.29×10⁶ and 6.47×10⁶.

When the simulation results (Tables 1 through 3) of the first through third samples and the simulation result of the fourth sample are compared, it is seen that the TMR device having the tunneling barrier layer 200 formed of TeO₂ has much lower resistances R1 and R2 than the resistances R1 and R2 of the TMR device having a tunneling barrier layer formed of MgO. Considering that the MR ratio (%) generally required in the TMR devices is 5% or more, and preferably, but not necessarily, 10% or more, the TMR device having a tunneling barrier layer formed of TeO₂ can have a MR ratio sufficiently large for using a read sensor. Accordingly, according to the exemplary embodiment of the present invention, even though the thickness of the tunneling barrier layer 200 is not reduced to 1 nm or less, the TMR device has a low resistance, and thus, a TMR device having low power consumption and high operation speed can be realized.

A single layer or a multilayer for fixing the magnetization direction of the pinned layer 100 can further be included on the lower surface of the pinned layer 100. The case where the single layer is formed on the lower surface of the pinned layer 100 is depicted in FIG. 2, and the case where the multilayer is formed on the lower surface of the pinned layer 100 is depicted in FIG. 3.

Referring to FIG. 2, the single layer can be an anti-ferromagnetic layer 40. When a ferromagnetic layer is formed on the anti-ferromagnetic layer 40 and an external magnetic field of a first direction is applied to the ferromagnetic layer at a temperature above the critical temperature, the magnetization direction of the ferromagnetic layer can be fixed in the first direction. The ferromagnetic layer having a magnetization direction which is fixed in the first direction is the pinned layer 100.

Referring to FIG. 3, the multilayer can include a non-magnetic conductive layer 80, another pinned layer 60, and an anti-ferromagnetic layer 40 sequentially formed on the lower surface of the pinned layer 100. The magnetization direction of the other pinned layer 60 is opposite to the magnetization direction of the pinned layer 100. When a first ferromagnetic layer, the non-magnetic conductive layer 80, and a second ferromagnetic layer are sequentially formed on the anti-ferromagnetic layer 40 and an external magnetic field of the first direction is applied to the first and second ferromagnetic layers at a temperature above the critical temperature, the magnetization direction of the first ferromagnetic layer can be fixed in the first direction. At this point, the magnetization direction of the second ferromagnetic layer is fixed in a second direction opposite to the first direction. The first ferromagnetic layer having a magnetization direction which is fixed in the first direction is the other pinned layer 60, and the second ferromagnetic layer having a magnetization direction which is fixed in the second direction is the pinned layer 100.

The TMR devices according to the present exemplary embodiments can be used, for example, as a read sensor in information storage apparatuses, can be used as an element of a memory cell in magnetic random access memories (MRAMs), and can be used as a detector for detecting a magnetic bio material.

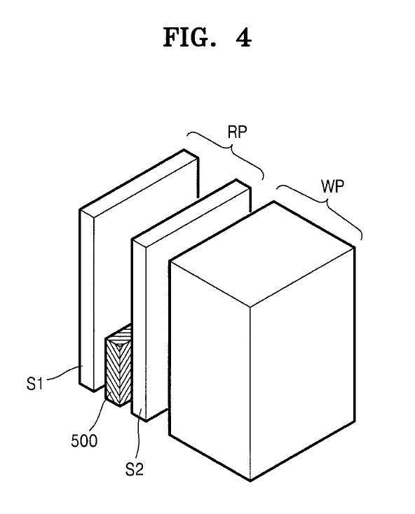

FIG. 4 is a perspective view of a magnetic head according to an exemplary embodiment of the present invention.

Referring to FIG. 4, the magnetic head according to the present exemplary embodiment includes a TMR device 500. The TMR device 500 may be one of the TMR devices of FIGS. 1 through 3. The TMR device 500 is located close to a recording medium (not shown) to discriminate the magnetization state of the surface of the recording medium. More specifically, the free layer 300 (refer to FIGS. 1 through 3) of the TMR device 500 is located close to the surface of the recording medium and, thus, the magnetization direction of the free layer 300 varies according to the magnetization state of the surface of the recording medium. The electrical resistance between the free layer 300 and the pinned layer 100 varies according to the magnetization direction of the free layer 300. Therefore, the magnetization state of the surface of the recording medium which is close to the free layer 300 can be discriminated by measuring the current that flows between the free layer 300 and the pinned layer 100.

A shielding layer can be formed at least one of the surfaces of the TMR device 500 facing each other. For example, as depicted in FIG. 4, first shielding layer S1 and second shielding layer S2 can be formed facing each other and adjacent to either surface of the TMR device 500. The TMR device 500 and the first and second shielding layers S1 and S2 can be included in a reproducing unit RP. The magnetic head according to the present exemplary embodiment can further include a magnetic writing unit WP located beside the second shielding layer S2. The magnetic writing unit WP can include a main pole, a coil that applies a magnetic field to the main pole, and a return pole that forms a magnetic path together with the main pole.

The magnetic head according to an exemplary embodiment of the present invention can be, for example, a perpendicular magnetic reading/recording apparatus or a longitudinal magnetic reading/recording apparatus.

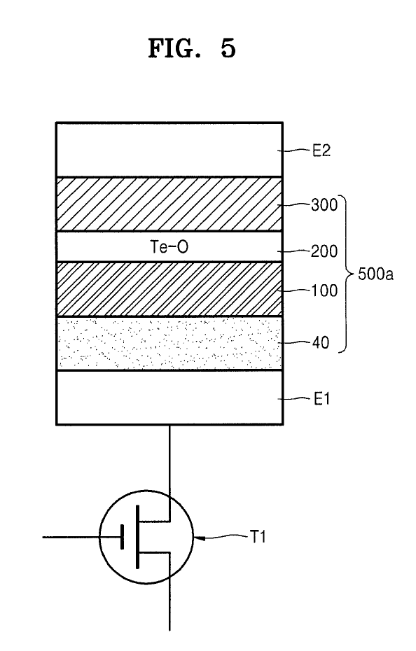

FIG. 5 is a cross-sectional view of a magnetic memory according to an exemplary embodiment of the present invention.

Referring to FIG. 5, a lower electrode E1 and an upper electrode E2 are respectively formed on lower and upper surfaces of a TMR device 500a. As shown in FIG. 5, the TMR device 500a may be the TMR device described in FIG. 2. One of the lower electrode E1 and the upper electrode E2, for example the lower electrode E1, is connected to a switching device. The switching device can be, for example, a transistor Ti. The lower electrode E1 and the upper electrode E2 can be formed in a line shape, and can cross each other. According to a voltage applied to the lower electrode E1 and the upper electrode E2, the magnetization direction of the free layer 300 of the TMR device 500a can change. In the present exemplary embodiment, the TMR device 500a which has the structure of FIG. 2 is used, however, the TMR device of FIG. 1 or FIG. 3 can alternatively be used.

As described above, a TMR device according to exemplary embodiments of the present invention use a Te—O layer having low resistance as the tunneling barrier layer 200. According to the exemplary embodiments of the present invention, a TMR device having a sufficiently high MR ratio with low resistance for use in a read sensor can be realized without reducing the thickness of the tunneling barrier layer 200. Therefore, the TMR device according to exemplary embodiments of the present invention can prevent problems related to reduction of the thickness of the tunneling barrier layer 200, such as non-uniformity of the device characteristics and low reliability of the TMR device, and can reduce power consumption and can increase the operation speed of the TMR device.

While the present invention has been particularly shown and described with reference to embodiments thereof, it should not be construed as being limited to the embodiments set forth herein. For example, the elements for constituting the TMR device according to the present embodiments can be diversified, and the tunneling barrier layer 200 can be a multilayer that includes Te—O. Therefore, the scope of the present invention shall be defined by the technical spirit of the appended claims set forth herein.

What is claimed is:

1. A tunneling magnetoresistive device comprising a pinned layer and a free layer formed on either side of a tunneling barrier layer, wherein the tunneling barrier layer includes Te—O.

2. The tunneling magnetoresistive device of claim 1, wherein the tunneling barrier layer is formed of TeO₂.

3. The tunneling magnetoresistive device of claim 1, wherein the tunneling barrier layer has a thickness of 0.5 to 4 nm.

4. The tunneling magnetoresistive device of claim 1, wherein the tunneling barrier layer has a resistance R(Ω·μm²) in a range of 0<R<4.

5. The tunneling magnetoresistive device of claim 2, wherein the tunneling barrier layer has a thickness of 0.5 to 4 nm.

6. The tunneling magnetoresistive device of claim 2, wherein the tunneling barrier layer has a resistance R(Ω·μm²) in a range of 0<R<4.

7. The tunneling magnetoresistive device of claim 1, further comprising an anti-ferromagnetic layer formed on a lower surface of the pinned layer.

8. The tunneling magnetoresistive device of claim 1, further comprising a non-magnetic conductive layer, another pinned layer having a magnetization direction opposite to a magnetization direction of the pinned layer, and an anti-ferromagnetic layer sequentially formed on the lower surface of the pinned layer.

9. A magnetic head comprising a reproducing unit that comprises a tunneling magnetoresistive device, wherein the tunneling magnetoresistive device comprises:
a tunneling barrier layer including Te—O; and
a free layer and a pinned layer formed on either side of the tunneling barrier layer.

10. The magnetic head of claim 9, wherein the tunneling barrier layer is formed of TeO₂.

11. The magnetic head of claim 9, wherein the tunneling barrier layer has a thickness of 0.5 to 4 nm.

12. The magnetic head of claim 9, wherein the tunneling barrier layer has a resistance R(Ω·λm²) in a range of 0<R<4.

13. The magnetic head of claim 10, wherein the tunneling barrier layer has a thickness of 0.5 to 4 nm.

14. The magnetic head of claim 10, wherein the tunneling barrier layer has a resistance R(Ω·μm²) in a range of 0<R<4.

15. The magnetic head of claim 9, further comprising a shielding layer formed adjacent to at least one of the surfaces of the tunneling magnetoresistive device.

16. The magnetic head of claim 9, further comprising a magnetic writing unit separated from the tunneling magnetoresistive device.

17. The tunneling magnetoresistive device of claim 1, wherein the magnetoresistive device has a first resistance R1 when the pinned layer and the free layer have the same magnetization directions and a second resistance R2 when magnetization directions of the pinned layer and the free layer are opposite;
wherein magnetoresistive device has an MR ratio of 5% or greater;
wherein the
$$MR ratio = \frac{R 2 - R 1}{R 1} .$$

18. The tunneling magnetoresistive device of claim 17, wherein the magnetoresistive device has an MR ratio of 10% or greater.

19. The magnetic head of claim 9, wherein the magnetoresistive device has a first resistance R1 when the pinned layer and the free layer have the same magnetization directions and a second resistance R2 when magnetization directions of the pinned layer and the free layer are opposite;
wherein magnetoresistive device has an MR ratio of 5% or greater;
wherein the
$$MR ratio = \frac{R 2 - R 1}{R 1} .$$

20. The magnetic head of claim 9, further comprising:
a first shielding layer adjacent to a first surface of the tunneling magnetoresistive device; and
a second shielding layer adjacent to a second surface of the tunneling magnetoresistive device;
wherein the first and second shielding layers face each other.
